(19) United States
(12) Patent Application Publication
(10) Pub. No.: US 2002/0146498 A1
(43) Pub. Date: Oct. 10, 2002

(54) Method for making instant mini-pasta

(76) Inventor: Avi Chriqui, Kfar Sava (IL)

Correspondence Address: Dekel Patent Ltd., Beit HaRofim, 18 Menuha VeNahala Street, Room 27, Rehovot, IL

(21) Appl. No.: 10/078,497

(22) Filed: Feb. 21, 2002

(30) Foreign Application Priority Data
Apr. 5, 2001 (IL) 142477

(51) Int. Cl. A23L 1/00

(52) U.S. Cl. 426/557

(57) ABSTRACT

A method for making an instant mini-pasta, e.g., maftul, including sifting flour, mixing water with the flour to form mini-pasta granules, steam-cooking the mini-pasta granules under pressure, and drying the mini-pasta.

### FIELD OF THE INVENTION

The present invention relates generally to mini-pasta, e.g., maftul, and methods for instant preparation thereof.

### BACKGROUND OF THE INVENTION

Maftul is a Palestinian dish, a type of mini-pasta, especially popular amongst Arabs in Israel, Jordan, Lebanon and Syria. Maftul (or meftul, depending on the Arabic dialect) is made only from flour and water, with no preservatives or additives whatsoever. Maftul consists of small round particles, similar in shape to another Middle Eastern dish, couscous, which originates from North Africa. However, couscous differs from maftul, in that couscous is made from semolina, not flour.

Traditionally, couscous and maftul are made from scratch from raw materials, a process that takes several hours. The present applicant has developed an instant mix for preparation of couscous, which has enjoyed much commercial success and which has widened the popularity of couscous. However, since maftul is made from flour, which behaves differently from semolina, it has been found that the method used for making instant couscous cannot be applied to making instant maftul. Accordingly, it would be advantageous to have a method for making instant mini-pasta made from flour, such as maftul.

### SUMMARY OF THE INVENTION

The present invention seeks to provide instant mini-pasta, e.g., maftul, and methods for preparation of instant mini-pasta.

There is thus provided in accordance with a preferred embodiment of the present invention a method for making an instant mini-pasta, e.g., maftul, including sifting flour, mixing water with the flour to form mini-pasta granules, steam-cooking the mini-pasta granules under pressure, and drying the mini-pasta.

In accordance with a preferred embodiment of the present invention the drying includes pre-drying the mini-pasta to remove vapors from the mini-pasta, and fully drying the mini-pasta.

Further in accordance with a preferred embodiment of the present invention the sifting is done with a single-mesh centrifugal sieve, such as a No. 40 sieve.

Still further in accordance with a preferred embodiment of the present invention the steam-cooking is done on a cooking conveyor that passes through pressurized steam.

In accordance with a preferred embodiment of the present invention the flour and water are mixed in a mixer with a water flow rate of generally 250 liters per hour, for example. The mini-pasta granules may be steam-cooked with a working pressure of generally 3.7 bars and a steam flow rate of generally 500 kg/hour. The mini-pasta may be pre-dried in an oven generally at 100° C. for 6 minutes, and fully dried in an oven generally at 110° C. for 25 minutes. It is stressed, however, that these are just exemplary values, and the invention is not limited to these values.

Further in accordance with a preferred embodiment of the present invention the minipasta is sorted into different sizes after fully drying.

The finished mini-pasta may be prepared by reconstituting the dried mini-pasta mix in boiling water for about 10 minutes.

### DETAILED DESCRIPTION OF A PREFERRED EMBODIMENT

The invention is described herein for making maftul. However, this is just one example of mini-pasta made from flour, and it is appreciated that the invention is applicable to other kinds of mini-pasta made from flour and is not limited to maftul.

Maftul is made from flour, preferably wheat flour, delivered from a flour manufacturer in sacks and the like. The flour is preferably inspected, for example, visually inspected for quality and moisture content. The flour is then typically stored in a storage area or container.

In accordance with one embodiment of the present invention, the flour is sifted, preferably using approximately a No. 40 sieve. (It is noted, however, that this is just an exemplary value, and the invention is not limited to this value.) The term “No. 40 sieve” refers to the United States Standard ASTM (American Standard of Testing Materials) E-II specification for testing fine and coarse sieves. In this standard, a No. 40 sieve has a nominal sieve opening of 419 μm (±19 μm) and a nominal wire diameter of 0.29 mm. This is in contrast to the preparation of instant couscous, wherein a No. 20 sieve is used to sift the semolina. In the ASTM E-II standard, a No. 20 sieve has a nominal sieve opening of 841 μm (±35 μm) and a nominal wire diameter of 0.51 mm. Moreover, in a preferred embodiment, the flour used to make instant maftul is sifted in a single-mesh centrifugal No. 40 sieve. In contrast, in the preparation of instant couscous, the semolina is sifted in a double-mesh rotating No. 20 sieve.

After sifting, the flour may be mixed thoroughly with water to form maftul granules. In a preferred embodiment, the flour and water are mixed in a mixer with a water flow rate of about 250 liters per hour. It is again stressed, however, that this is just an exemplary value, and the invention is not limited to this value.

The maftul granules (flour-water mixture) may be then steam-cooked under pressure to form maftul, such as on a cooking conveyor that passes through pressurized steam. For example, the working pressure may be about 3.7 bars and the steam flow rate may be about 500 kg/hour. (Again the invention is not limited to these values.) The maftul is preferably visually (or otherwise) inspected during cooking.

The cooked maftul may be then dried, preferably by means of pre-drying and final drying. The main purpose of the pre-drying is to remove vapors from the maftul. Pre-drying may consist of drying in an oven at about 100° C. for 6 minutes. (Again the invention is not limited to these values.) The pre-dried maftul may be then fully (final) dried, such as in an oven at about 110° C. for 25 minutes. (Again the invention is not limited to these values.) The finished maftul preferably undergoes various inspections, such as, but not limited to, moisture content, consistency, quality and the like. After passing inspection, the maftul may be packed, which may comprise sorting the maftul into different sizes and packing the different sizes. The packaged maftul is then stored until sale or use.

The finished maftul may be prepared by reconstituting the dried maftul mix in boiling water for about 10 minutes.

It will be appreciated by person skilled in the art, that the present invention is not limited by what has been particularly shown and described herein above. Rather the scope of the present invention is defined only by the claims that follow:

What is claimed is:

1. A method for making mini-pasta, comprising:
sifting flour;
mixing water with said flour to form mini-pasta granules;
steam-cooking said mini-pasta granules under pressure to form mini-pasta; and
drying said mini-pasta.

2. The method according to claim 1 wherein said drying comprises:
pre-drying said mini-pasta to remove vapors from said mini-pasta; and
fully drying said mini-pasta.

3. The method according to claim 1 wherein said sifting comprises sifting with a single-mesh centrifugal sieve.

4. The method according to claim 1 wherein said steam-cooking comprises steam-cooking said mini-pasta granules on a cooking conveyor that passes through pressurized steam.

5. The method according to claim 1 wherein said sifting comprises sifting generally with a No. 40 sieve as defined in accordance with the ASTM (American Standard of Testing Materials) E-II specification for testing fine and coarse sieves.

6. The method according to claim 1 wherein said mixing comprises mixing said flour and water in a mixer with a water flow rate of generally 250 liters per hour.

7. The method according to claim 1 wherein said steam-cooking comprises steam-cooking said mini-pasta granules with a working pressure of generally 3.7 bars and a steam flow rate of generally 500 kg/hour.

8. The method according to claim 2 wherein said pre-drying comprises pre-drying in an oven generally at 100° C. for 6 minutes.

9. The method according to claim 2 wherein said fully drying comprises fully drying said mini-pasta in an oven generally at 110° C. for 25 minutes.

10. The method according to claim 1 and further comprising sorting said mini-pasta into different sizes after fully drying.

11. The method according to claim 1 wherein said mixing comprises mixing water with said flour to form maftul granules.

12. An instant mini-pasta comprising mini-pasta made by:
sifting flour;
mixing water with said flour to form mini-pasta granules;
steam-cooking said mini-pasta granules under pressure to form mini-pasta; and
drying said mini-pasta.

13. The instant mini-pasta according to claim 12 wherein said mini-pasta comprises maftul.
